(19) United States
(12) Patent Application Publication
(10) Pub. No.: US 2014/0127318 A1
(43) Pub. Date: May 8, 2014

(54) BACTERIAL AND FUNGICIDAL COMPOSITION FOR PLANTS AND CROPS

(71) Applicant: Robert Larose, East Hartford, CT (US)

(72) Inventor: Robert Larose, East Hartford, CT (US)

(21) Appl. No.: 14/072,466

(22) Filed: Nov. 5, 2013

Related U.S. Application Data
(60) Provisional application No. 61/722,970, filed on Nov. 6, 2012.

(51) Int. Cl. A01N 59/26; A01N 59/00

(52) U.S. Cl. CPC A01N 59/26; A01N 59/00
USPC 424/605

(57) ABSTRACT

Compositions comprising an effective amount of (1) hydrogen peroxide, an organic peroxide or a combination thereof; and (2) phosphorous acid, mono- and/or di-salts of phosphorous acid or a combination thereof are effective in preventing or controlling diseases in plants caused by pathogens. The disclosed compositions can be used by contacting a plant with an effective amount of such compositions.

### CROSS-REFERENCE TO RELATED APPLICATION

This is a utility application which claims the benefit of U.S. Provisional Patent Application No: 61/722,970, filed Nov. 6, 2012.

### BACKGROUND OF THE INVENTION

### Field of the Invention

Plant pathogens constitute one of the main causes of crop yield reduction and may also render the crop a lower grade by causing blemishes, blights or other quality problems. Plant pathogens in general include but are not limited to bacteria, fungi, fungi-like organisms belonging to oomycete group (FLO) such as Pythium, Phytophthora Peronospora and viruses. Bacteria, fungi and FLO's in particular occur more commonly in the field and in most cases, the level of disease incidence and severity caused by these pathogens in the field is directly proportional to total and marketable yield losses. Some of these pathogens also carry over onto harvested commodities and can result in significant spoilage and decay during storage. Some fungi can also contaminate the produce by releasing mycotoxins that can be detrimental to humans and animals. In addition to losses on growing in-field crops, harvested commodities can also be affected leading to damage ranging from rancidity, odor, flavor changes, loss of nutrients, and germ layer destruction. This can result in a reduction in the quality, as well as gross spoilage and possible mycotoxin production.

Losses caused by postharvest diseases are greater than generally realized because the value of fresh fruits and vegetables can increase by as much as a factor of seven while passing from the field to the consumer. It has been estimated that postharvest losses range from 10 to 30% per year despite the use of modern storage facilities and techniques. The reduction of losses in perishable food crops because of postharvest diseases has become a major objective of international organizations. For example, crop losses due to storage diseases in potatoes can exceed 7.5% Late blight, pink rot, and silver scurf diseases caused by Phytophthora infestans, Phytophthora erythroseptica and Helminthosporium solani, respectively, are three of the most economically important storage diseases of potatoes worldwide. Unless properly treated before storage, seed potatoes already infected with P. infestans may spread the disease onto healthy seed in storage which would lead to storage problems and can impact the next season's crop. A number pesticides containing phosphorous acid are available for the control of diseases in crops. However, current phosphorus acid based products have a narrow spectrum of activity in being effective on oomycete class of FLO's such as Pythium, Phytophthora and Peronospora. They have limited or no effect on other plant fungi or bacteria. What is needed are compositions and methods that are broad spectrum in their activity and that are effective in protecting plants and crops from pathogenic infections and/or pre- and post-harvest pathogenic organisms which include bacteria and fungi.

### SUMMARY OF THE INVENTION

One aspect of the present invention pertains to compositions comprising (1) hydrogen peroxide, an organic peroxide or a combination thereof; and (2) phosphorous acid, mono- and/or di-salts of phosphorous acid or a combination thereof.

Another aspect of the present invention pertains to a method of preventing or controlling pathogenic diseases in plants comprising contacting the plant with an effective amount of a composition comprising (1) hydrogen peroxide, an organic peroxide or a combination thereof; and (2) phosphorous acid, mono- and/or di-salts of phosphorous acid or a combination thereof.

Yet another aspect of the present invention pertains to a method of preventing or killing post-harvest and/or storage disease pathogens on fruits and/or vegetables comprising contacting a fruit or vegetable with an effective amount of a composition comprising (1) hydrogen peroxide, an organic peroxide or a combination thereof; and (2) phosphorous acid, mono- and/or di-salts of phosphorous acid or a combination thereof. Such a method is particularly effective against pathogens selected from the group consisting of P. infestans, P. erythroseptica, H. solani and combinations thereof.

Still another aspect of the present invention pertains to a method of preventing or eliminating pathogenic infections on the root zone of a plant comprising contacting the root zone of a plant with an effective amount of a composition comprising (1) hydrogen peroxide, an organic peroxide or a combination thereof; and (2) phosphorous acid, mono- and/or di-salts of phosphorous acid or a combination thereof.

The compositions according to the invention are effective in a wide variety of pre- and post-harvest anti-microbial crop applications. Pre-harvest applications include protection from both bacterial and fungal diseases on the foliar portion of the plant from foliar/above ground sprays/tree injection as well as protection from soil borne diseases caused by bacteria, fungi and oomycete class of FLO's such as Ralstonia, Pythium Phytophthora, Rhizoctonia and Verticillium. The inventive compositions are effective against post-harvest pathogens that are the cause of spoilage and decay, including bacterial and fungal pathogens. The inventive compositions are particularly effective against post-harvest pathogens on potatoes that are susceptible to Pythium pink rot. The inventive compositions are also effective for golf courses and landscape turf applications.

### DETAILED DESCRIPTION

The aforementioned problems with current anti-microbial products for agricultural applications can be solved by the use of compositions and methods according to the present invention. Such compositions and methods allow the user to treat both fungal and bacterial pathogens that attack plants and/or the fruits and vegetables produced by such plants.

Compositions according to the invention are comprised of (1) hydrogen peroxide, an organic peroxide or a combination thereof; and (2) phosphorous acid, mono- and/or di- salts of phosphorous acid or a combination thereof. The organic peroxides that can be used in the inventive compositions include peroxycarboxylic acids and their salts. The mono and/or di- salts of phosphorous acid include alkali metal salts, sodium salts, ammonium salts including mono-, di- and tri-C₁₋₅ alkyl ammonium salts and combination of potassium and sodium salts. Mono- and/or di-potassium salts of phosphorous acid are preferred. The amount of hydrogen peroxide, an organic peroxide or a combination thereof can range from about 12 to about 18% by weight of the composition. The amount of the phosphorous acid, mono- and/or di-salts of phosphorous acid or a combination thereof can range from about 25 to about 30% by weight of the composition. The compositions according to the invention can also contain additives such as corrosion inhibitors such as HEDP (hydroxyethylidene-1,1-diphosphonic Acid), chelating agents such as EDTA, surfactants, and the like.

The typical amount of the compositions according to the invention that can be used in the methods described herein can range from 1:2.5 dilution to about 1:1000 dilution rate applied at from about 30 to about 100 gallons of spray solution per treated acre. The optimal amount can vary depending upon crop commodity and disease and can be readily determined by those of ordinary skill in the art. The compositions according to the invention can be applied to a plant by contacting it any means known to those skilled in the art. Examples of such methods include, but are not limited to foliar spraying, foliar painting, root injection, tree trunk injection, plant stem injection and in-furrow at the time of planting wherein the composition is applied as a band directly over the seed pieces prior to row closure. Typically, spraying is carried out from tractor-mounted sprayers, by crop dusting, through pressurized sprinklers, and through systems such as elevated hoses used to spray grapevines. The term “contacting” as used herein means causing the plant, plant root or plant seeds to come into proximity with an exogenous liquid or solid (such as a powder) form of a composition according to the invention.

The following example is meant to illustrate but not to limit the invention. Example: In vitro screening of Comp. A against Phytophthora infestans, Phytophthora erythroseptica and Helminthosporium solani.

The ingredients of “Comp. A,” a composition according to the invention, are listed. The entries under the treatments column refer to the relative amounts of Comp. A to water. For example, 1:17 means 1 part of Comp. A to 17 parts of water, etc.

Comp. A.

| | |
|---|---|
| Mono and di-potassium salts of phosphorus acid | 27.1% |
| Hydrogen dioxide | 14.0% |
| HEDP | 1.0% |
| Water | 57.9% |

### Pathogen Isolates.

P. infestans (isolate P12010-028NB and isolate P12010-034PE), P. erythroseptica (isolate PE2008-152NB and isolate PE364-2NB) and H. solani (isolate HS2001 PE and isolate HS-Pot-1-Col-1-AB) from the culture collection of Potato Development Centre, Wicklow, New Brunswick, Canada were sub-cultured on rye seed agar (RSA), 15% clarified V8 juice agar or Potato Dextrose Agar (PDA) (EMD Chemicals, Inc., Germany) respectively before the test started.

### Post-Harvest Fungicides.

Comp. A; Confine™ (45.8% mono- and di-potassium salts of phosphorous acid) a trademark of Agromart Company of Canada Ltd., Thorndale, Ontario, Canada, and StorOx® (27% by weight of hydrogen peroxide), a registered trademark of BioSafe Systems LLC, were used in the testing below.

### Treatments.

The trial included eight treatments: [1] Control; [2] Comp. A 1:17; [3] Comp. A 1:100; [4] Comp. A 1:300; [5] Comp. A 1:1000; [6] Comp. A 1:3000; [7] StorOx1:100; and [8] Confine 1:17. P. infestans isolates were cultured on 15 ml of RSA containing Comp. A, StorOx or Confine according to the above ratios. Isolates of P. erythroseptica and H. solani were cultured on similarly amended V8 agar or PDA plates, respectively.

### Experimental Conditions.

The plates were inoculated with agar plugs of 5 mm diameter fungal cultures obtained from growing edges of each isolate. All plates were sealed using Parafilm before incubation. Six replicates (plates) were employed for each treatment and were incubated at 22 EC under normal light and dark regimen.

### Assessments.

Two perpendicular measurements along the radial mycelial growth of the pathogens were taken until the respective control plates reached the edge of the plates. However, the measurement with relation to H. solani growth was terminated in advance due to the normal slower growth rate of this pathogen.

Statistical analyses: Analysis of variance (ANOVA) was used to separate means according to LSD (0.05) using CoStat (CoHort Software, Monterey, Calif., USA) and the treatment means were compared using LSD test at p<0.05.

### Results.

Tables 1 and 2 demonstrate the dynamics of in vitro growth of two isolates of P. erythroseptica (isolate PE2008-152NB and isolate PE364-2NB respectively) on clarified V-8 agar amended with Comp. A at different ratios. Two isolates were completely inhibited by Comp. A at 1:300 and higher concentrations such as 1:100 and 1:17. Comp. A was not inhibitive for both isolates at 1:1000 and higher dilutions such as 1:3000.

Tables 3 and 4 demonstrate the in vitro growth of two isolates of P. infestans (isolate P12010-028NB and isolate P12010-034PE respectively) on RSA amended with Comp. A at different ratios. None of the used concentration of Comp. A in RSA was favorable for the growth of both P. infestans isolates.

Tables 5 and 6 show the in vitro growth of two isolates of H. solani (isolate HS2001PE and isolate HS-Pol-1-Col-1-AB, respectively) on PDA amended with Comp. A at different ratios. As the growth of the two isolates on PDA was too slow, but comparable, we were compelled to finalize the results in advance. According to the results, Comp. A at 1:17 was completely inhibitive for both of the H. solani isolates, which is comparable to the inhibition due to Confine at 1:17 or StorOx at 1:100. Comp. A at dilutions over 1:17 such as 1:100 was completely inhibitive to both of the H. solani isolates up to 22 days. However, thereafter H. solani (isolate HS2001 PEI and isolate HS-Pol-1-Col-1-AB) started growing slowly, although the inhibition at the end of the assessment was 80.2% and 40.6% respectively. Similarly, Comp. A at 1:300 in agar inhibited the in vitro growth of H. solani (isolate HS2001 PEI and isolate HS-Pol-1-Col-1-AB respectively) by 21.2% and 2.2%, respectively.

TABLE 1
In vitro growth of P. erythroseptica (isolate PE2008-152NB) on clarified
V-8 agar amended with Composition A at different ratios.

| | Days after (mm) | | | | | |
|---|---|---|---|---|---|---|
| Treatments | 1 | 2 | 3 | 4 | 5 | % Inhibition* |
| Control | 10.3^{a} | 16.9^{a} | 24.2^{a} | 32.1^{a} | 40.0^{a} | |
| Comp. A 1:17 | 0.0^{d} | 0.0^{d} | 0.0^{d} | 0.0^{d} | 0.0^{d} | 100 |
| Comp. A 1:100 | 0.0^{d} | 0.0^{d} | 0.0^{d} | 0.0^{d} | 0.0^{d} | 100 |
| Comp. A 1:300 | 0.0^{d} | 0.0^{d} | 0.0^{d} | 0.0^{d} | 0.0^{d} | 100 |
| Comp. A 1:1000 | 3.8^{c} | 6.6^{c} | 10.7^{c} | 14.0^{c} | 17.6^{c} | 56.0 |
| Comp. A 1:3000 | 6.3^{b} | 10.9^{b} | 15.2^{b} | 19.0^{b} | 23.1^{b} | 42.2 |
| StorOx 1:100 | 0.0^{d} | 0.0^{d} | 0.0^{d} | 0.0^{d} | 0.0^{d} | 100 |
| Confine 1:17 | 0.0^{d} | 0.0^{d} | 0.0^{d} | 0.0^{d} | 0.0^{d} | 100 |
| LSD (0.05) | 0.261 | 0.203 | 0.200 | 0.273 | 0.299 | |
| df = 35 | | | | | | |

Data are means of six replicates. Each replicate value is the mean of four perpendicular measurements.
*Calculated based on measurements taken after 5 days. Values with different letters in columns are significantly different from each other according to the LSD at p ≧ 0.05.

TABLE 2
In vitro growth of P. erythroseptica (isolate PE364-2NB) on clarified V-8 agar
amended with Composition A at different ratios.

| | Days after (mm) | | | | | |
|---|---|---|---|---|---|---|
| Treatments | 1 | 2 | 3 | 4 | 5 | % Inhibition* |
| Control | 10.9^{a} | 18.7^{a} | 25.9^{a} | 34.0^{a} | 40.0^{a} | B |
| Comp. A 1:17 | 0.0^{d} | 0.0^{d} | 0.0^{d} | 0.0^{d} | 0.0^{d} | 100 |
| Comp. A 1:100 | 0.0^{d} | 0.0^{d} | 0.0^{d} | 0.0^{d} | 0.0^{d} | 100 |
| Comp. A 1:300 | 0.0^{d} | 0.0^{d} | 0.0^{d} | 0.0^{d} | 0.0^{d} | 100 |
| Comp. A 1:1000 | 2.9^{c} | 6.2^{c} | 10.2^{c} | 13.4^{c} | 17.2^{c} | 57.0 |
| Comp. A. 1:3000 | 6.1^{b} | 10.7^{b} | 15.3^{b} | 19.8^{b} | 24.3^{b} | 39.2 |
| StorOx7 1:100 | 0.0^{d} | 0.0^{d} | 0.0^{d} | 0.0^{d} | 0.0^{d} | 100 |
| Confine7 1:17 | 0.0^{d} | 0.0^{d} | 0.0^{d} | 0.0^{d} | 0.0^{d} | 100 |
| LSD (0.05) | 0.621 | 0.146 | 0.277 | 0.454 | 0.400 | |
| df = 35 | | | | | | |

Data are means of six replicates. Each replicate value is the mean of four perpendicular measurements.
*Calculated based on measurements taken after 5 days. Values with different letters in columns are significantly different from each other according to the LSD at p ≧ 0.05.

TABLE 3
In vitro growth of P. infestans (isolate PI2010-028NB) on rye seed agar
amended with Composition A at different ratios.

| | Days after (mm) | | | | | | | |
|---|---|---|---|---|---|---|---|---|
| Treatments | 5 | 6 | 10 | 13 | 16 | 19 | 22 | % Inhibition* |
| Control | 7.92^{a} | 13.5^{a} | 16.2^{a} | 22.6^{a} | 26.3^{a} | 29.9^{a} | 32.7^{a} | |
| Comp. A 1:17 | 0.0^{b} | 0.0^{b} | 0.0^{b} | 0.0^{b} | 0.0^{b} | 0.0^{b} | 0.0^{b} | 100 |
| Comp. A 1:100 | 0.0^{b} | 0.0^{b} | 0.0^{b} | 0.0^{b} | 0.0^{b} | 0.0^{b} | 0.0^{b} | 100 |
| Comp. A 1:300 | 0.0^{b} | 0.0^{b} | 0.0^{b} | 0.0^{b} | 0.0^{b} | 0.0^{b} | 0.0^{b} | 100 |
| Comp. A 1:1000 | 0.0^{b} | 0.0^{b} | 0.0^{b} | 0.0^{b} | 0.0^{b} | 0.0^{b} | 0.0^{b} | 100 |
| Comp. A 1:3000 | 0.0^{b} | 0.0^{b} | 0.0^{b} | 0.0^{b} | 0.0^{b} | 0.0^{b} | 0.0^{b} | 100 |
| StorOx7 1:100 | 0.0^{b} | 0.0^{b} | 0.0^{b} | 0.0^{b} | 0.0^{b} | 0.0^{b} | 0.0^{b} | 100 |
| Confine7 1:17 | 0.0^{b} | 0.0^{b} | 0.0^{b} | 0.0^{b} | 0.0^{b} | 0.0^{b} | 0.0^{b} | 100 |
| LSD (0.05) | 0.223 | 0.400 | 0.421 | 0.930 | 1.169 | 1.237 | 1.184 | 100 |
| df = 35 | | | | | | | | |

Data are means of six replicates. Each replicate value is the mean of four perpendicular measurements.
*Calculated based on measurements taken after 22 days. Values with different letters in columns are significantly different from each other according to the LSD at p ≧ 0.05.

TABLE 4
In vitro growth of P. infestans (isolate PI2010-034PE) on rye seed agar
amended with Composition A at different ratios.

| | Days after (mm) | | | | | | | |
|---|---|---|---|---|---|---|---|---|
| Treatments | 5 | 8 | 10 | 13 | 16 | 19 | 22 | % Inhibition* |
| Control | 6.7^{a} | 13.0^{a} | 15.7^{a} | 24.4^{a} | 31.7^{a} | 37.2^{a} | 39.9^{a} | |
| Comp. A 1:17 | 0.0^{b} | 0.0^{b} | 0.0^{b} | 0.0^{b} | 0.0^{b} | 0.0^{b} | 0.0^{b} | 100 |
| Comp. A 1:100 | 0.0^{b} | 0.0^{b} | 0.0^{b} | 0.0^{b} | 0.0^{b} | 0.0^{b} | 0.0^{b} | 100 |
| Comp. A 1:300 | 0.0^{b} | 0.0^{b} | 0.0^{b} | 0.0^{b} | 0.0^{b} | 0.0^{b} | 0.0^{b} | 100 |
| Comp. A 1:1000 | 0.0^{b} | 0.0^{b} | 0.0^{b} | 0.0^{b} | 0.0^{b} | 0.0^{b} | 0.0^{b} | 100 |
| Comp. A 1:3000 | 0.0^{b} | 0.0^{b} | 0.0^{b} | 0.0^{b} | 0.0^{b} | 0.0^{b} | 0.0^{b} | 100 |
| StorOx7 1:100 | 0.0^{b} | 0.0^{b} | 0.0^{b} | 0.0^{b} | 0.0^{b} | 0.0^{b} | 0.0^{b} | 100 |
| Confine7 1:17 | 0.0^{b} | 0.0^{b} | 0.0^{b} | 0.0^{b} | 0.0^{b} | 0.0^{b} | 0.0^{b} | 100 |
| LSD (0.05) | 0.270 | 0.152 | 0.185 | 0.312 | 0.571 | 0.323 | 0.034 | |
| df = 35 | | | | | | | | |

Data are means of six replicates. Each replicate value is the mean of four perpendicular measurements.
*Calculated based on measurements taken after 22 days. Values with different letters in columns are significantly different from each other according to the LSD at p ≧ 0.05.

TABLE 5
In vitro growth of H. solani (isolate HS2001PE) on potato dextrose agar
amended with Composition A at different ratios.

| | Days after (mm) | | | | | |
|---|---|---|---|---|---|---|
| Treatments | 8 | 15 | 22 | 29 | 36 | % Inhibition* |
| Control | 4.5^{a} | 7.5^{a} | 10.4^{a} | 13.3^{a} | 1.56^{a} | C |
| Comp. A 1:17 | 0.0^{e} | 0.0^{d} | 0.0^{c} | 0.0^{e} | 0.0^{e} | 100 |
| Comp. A 1:100 | 0.0^{e} | 0.0^{d} | 0.0^{c} | 2.5^{d} | 3.08^{d} | 80.2 |
| Comp. A 1:300 | 2.5^{d} | 4.0^{c} | 6.9^{b} | 9.2^{c} | 12.3^{c} | 21.2 |
| Comp. A 1:1000 | 3.6^{c} | 6.5^{b} | 9.7^{a} | 12.1^{b} | 14.6^{b} | 6.4 |
| Comp. A 1:3000 | 4.1^{b} | 7.2^{a} | 9.9^{a} | 12.3^{b} | 15.1^{ab} | 3.2 |
| StorOx7 1:100 | 0.0^{e} | 0.0^{d} | 0.0^{c} | 0.0^{e} | 0.0^{e} | 100 |
| Confine7 1:17 | 0.0^{e} | 0.0^{d} | 0.0^{c} | 0.0^{e} | 0.0^{e} | 100 |
| LSD (0.05) | 0.240 | 0.509 | 0.752 | 0.881 | 0.986 | |
| df = 35 | | | | | | |

Data are means of six replicates. Each replicate value is the mean of four perpendicular measurements.
*Calculated based on measurements taken after 36 days. Values with different letters in columns are significantly different from each other according to the LSD at p ≧ 0.05.

TABLE 6
In vitro growth of H. solani (isolate HS-Pol-1-Col-1-AB) on potato dextrose agar
amended with Composition A at different ratios.

| | Days after (mm) | | | | | |
|---|---|---|---|---|---|---|
| Treatments | 8 | 15 | 22 | 29 | 36 | % Inhibition* |
| Control | | | | | | C |
| Comp. A 1:17 | 0.0^{d} | 0.0^{d} | 0.0^{d} | 0.0^{e} | 0.0^{d} | 100 |
| Comp. A 1:100 | 0.0^{d} | 0.0^{d} | 0.0^{d} | 5.0^{d} | 8.2^{c} | 40.6 |
| Comp. A 1:300 | 2.9^{c} | 5.1^{c} | 8.1^{c} | 11.2^{c} | 13.5^{b} | 2.2 |
| Comp. A 1:1000 | 4.1^{b} | 8.0^{b} | 11.5^{a} | 13.5^{a} | 15.3^{a} | C |
| Comp. A 1:3000 | 4.5^{ab} | 8.7^{a} | 11.9^{a} | 13.9^{a} | 15.9^{a} | C |
| StorOx7 1:100 | 0.0^{d} | 0.0^{d} | 0.0^{d} | 0.0^{e} | 0.0^{d} | 100 |
| Confine7 1:17 | 0.0^{d} | 0.0^{d} | 0.0^{d} | 0.0^{e} | 0.0^{d} | 100 |
| LSD (0.05) | 0.383 | 0.412 | 0.489 | 0.514 | 0.699 | |
| df = 35 | | | | | | |

Data are means of six replicates. Each replicate value is the mean of four perpendicular measurements.
*Calculated based on measurements taken after 36 days. Values with different letters in columns are significantly different from each other according to the LSD at p ≧ 0.05.

1. A composition comprising (1) hydrogen peroxide, an organic peroxide or a combination thereof; and (2) phosphorous acid, mono- and/or di-salts of phosphorous acid or a combination thereof.

2. A composition according to claim 1 comprising hydrogen peroxide, a mono-salt of phosphorous acid and a di-salt of phosphorous acid.

3. A composition according to claim 1 comprising an organic peroxide a mono-salt of phosphorous acid and a di-salt of phosphorous acid.

4. A composition according to claim 2 wherein the mono-salt of phosphorous acid and di-salt of phosphorous acid are mono- and di-potassium salts of phosphorous acid.

5. A composition according to claim 1 wherein the amount of hydrogen peroxide, organic peroxide, or combination thereof ranges from 12 to about 18% by weight of the composition, and the amount of the phosphorous acid, mono- and/or di-salts of phosphorous acid or a combination thereof ranges from about 25 to about 30% by weight of the composition.

6. A method of preventing or controlling pathogenic diseases in plants comprising contacting the plant with an effective amount of a composition comprising (1) hydrogen peroxide, an organic peroxide or a combination thereof; and (2) phosphorous acid, mono- and/or di-salts of phosphorous acid or a combination thereof.

7. A method according to claim 6 wherein the composition comprises hydrogen peroxide, a mono-salt of phosphorous acid and a di-salt of phosphorous acid.

8. A method according to claim 6 wherein the composition comprises an organic peroxide a mono-salt of phosphorous acid and a di-salt of phosphorous acid.

9. A method according to claim 8 wherein the composition comprises the mono-salt of phosphorous acid and di-salt of phosphorous acid are mono- and di-potassium salts of phosphorous acid.

10. A method according to claim 6 wherein the amount of hydrogen peroxide, organic peroxide, or combination thereof ranges from 12 to about 18% by weight of the composition, and the amount of the phosphorous acid, mono- and/or di-salts of phosphorous acid or a combination thereof ranges from about 25 to about 30% by weight of the composition.

11. A method of preventing or killing post-harvest and/or storage disease pathogens on fruits and/or vegetables comprising contacting a fruit or vegetable with an effective amount of a composition comprising (1) hydrogen peroxide, an organic peroxide or a combination thereof; and (2) phosphorous acid, mono- and/or di-salts of phosphorous acid or a combination thereof.

12. A method according to claim 11 wherein the composition comprises wherein the composition comprises hydrogen peroxide, a mono-salt of phosphorous acid and a di-salt of phosphorous acid.

13. A method according to claim 11 wherein the composition comprises an organic peroxide a mono-salt of phosphorous acid and a di-salt of phosphorous acid.

14. A method according to claim 13 wherein the composition comprises the mono-salt of phosphorous acid and di-salt of phosphorous acid are mono- and di-potassium salts of phosphorous acid.

15. A method according to claim 11 wherein the amount of hydrogen peroxide, organic peroxide, or combination thereof ranges from 12 to about 18% by weight of the composition, and the amount of the phosphorous acid, mono- and/or di-salts of phosphorous acid or a combination thereof ranges from about 25 to about 30% by weight of the composition.
